(19) United States
(12) Patent Application Publication
(10) Pub. No.: US 2015/0245727 A1
(43) Pub. Date: Sep. 3, 2015

(54) STRAWBERRY HULLER

(71) Applicant: Robinson Home Products Inc., Williamsville, NY (US)

(72) Inventors: Lou Henry, Scarsdale, NY (US); John Healy, Brooklyn, NY (US)

(73) Assignee: Robinson Home Products Inc., Williamsville, NY (US)

(21) Appl. No.: 14/194,244

(22) Filed: Feb. 28, 2014

(51) Int. Cl. A47J 25/00

(52) U.S. Cl. CPC A47J 25/00

(57) ABSTRACT

A strawberry huller for removing stems and cores from strawberries having a tubular member and a receptacle for holding a plurality of stems and cores. The tubular member has a first end with a cutting edge for cutting the stems and cores from a strawberry, a second end for delivering the removed stems and cores to the receptacle 6 and a through aperture. The receptacle preferably includes a receptacle body and a cover over an opening for emptying the stems and cores from the receptacle, where the opening is independent of the through aperture of the tubular member.

### FIELD OF THE INVENTION

The present invention relates to a kitchen device, and more specifically to a device for removing the cores and stems of strawberries from the fruit.

### BACKGROUND OF THE INVENTION

Although many people enjoy strawberries, the stems and often the cores are not usually eaten so that they need to be removed prior to strawberries being served in various dishes. Removal of the stems and cores may be done with the use of a knife, cutting around the stem and into the core, but such methods are time consuming, lead to uneven results and may unnecessarily waste edible portions of the strawberry flesh.

One attempt to solve these issues is found in U.S. Patent Publication No. 2008/0271321, which describes a strawberry huller that removes a strawberry core and ejects it after each use. However, such a device requires considerable time to clean a number of strawberries. In this regard, use of the device requires that the user remove the stem and core of one strawberry, clear the device by ejecting the core into a separate waste receptacle, such as a garbage can or a bowl, and then start again on the next strawberry. It also creates the need to work over a garbage can or clean the bowl used as a waste receptacle.

The difficulty in preparing a number of strawberries quickly and efficiently has led to the limited use of strawberries as a bulk fruit. Therefore, a device that could quickly and easily clean a number of strawberries in a uniform and efficient manner, preserving more of the edible portions of the strawberry, while simultaneously limiting cleanup, would advance the art.

### SUMMARY OF THE INVENTION

The present invention addresses these and other deficiencies of the prior art, which is directed to a strawberry huller comprising a tubular member having a first end, a second end and a through aperture, the first end having a cutting edge for cutting the stems and cores, and a receptacle associated with the with the second end of the tubular member for receiving a plurality of strawberry stems and cores, the receptacle comprising an opening for removing stems and cores received therein, wherein the opening being an opening independent of the through aperture of the tubular member.

The receptacle may hold any number of stems and cores as a matter of design choice, dictated by the size of the receptacle, however, a receptacle designed to hold about 25-35 stems and cores is generally suitable.

Although the opening can be adapted to receive the tubular member, it is preferred that the receptacle comprise a receptacle body and a cover for recloseably sealing the opening. In this embodiment, the tubular member is preferably fixed to the receptacle body and the cover may be attached to and removed from the receptacle body.

Preferably, the receptacle body includes areas to grasp the strawberry huller without grasping the cover, which may be flattened areas or may comprise a tactile surface for improving the handling of the strawberry huller when in use. Internal structural supports may also be included to help maintain the shape of the receptacle when grasped during use.

It is also preferred that at least a portion of the receptacle is clear to determine when to remove the stems and cores received therein, and most preferred that the cover is the clear portion. Additionally, the cover is preferably snap fit into place, with flexible sides, a tab or other element associated with the cover to more easily remove it from the receptacle body.

The tubular member of the present invention is cylindrical or slightly tapered smaller at the first end to remove the stems and cores of strawberries. The stems and cores removed are pushed up through the through aperture of the tubular member into the receptacle by successive stems and cores from the next strawberries cleaned. The cutting edge of the first end may be straight, but it is preferred that the cutting edge have an undulating or serrated edge to more cleanly cut into the strawberry flesh around the stem and core to be removed.

The strawberry huller can be made of any suitable materials. In this regard, the tubular member is preferably made of a food grade stainless steel and the receptacle, including the receptacle body and cover, is preferably made from a plastic, such as a thermoplastic or thermoset elastomeric material.

### BRIEF DESCRIPTION OF THE DRAWINGS

The present invention will be better understood when considered in view of the attached drawings, in which like reference characters indicate like parts. The drawings, however, are presented merely to illustrate the preferred embodiment of the invention without limiting the invention in any manner whatsoever.

FIG. 1 is a perspective view of a preferred embodiment of the strawberry huller of the present invention.

FIG. 2 is a side elevation of the preferred embodiment of the strawberry huller of FIG. 1.

FIG. 3 is an exploded side elevation of the preferred embodiment of the strawberry huller of FIG. 1.

### DETAILED DESCRIPTION OF THE PREFERRED EMBODIMENT

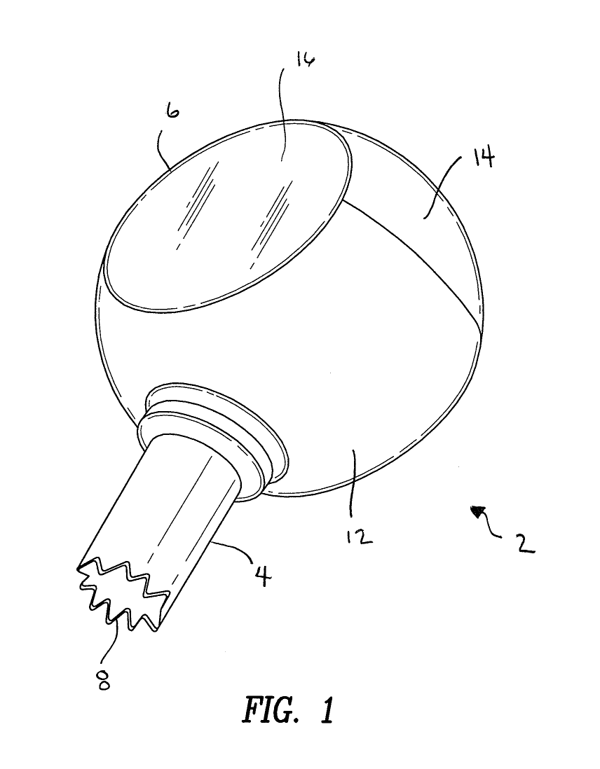

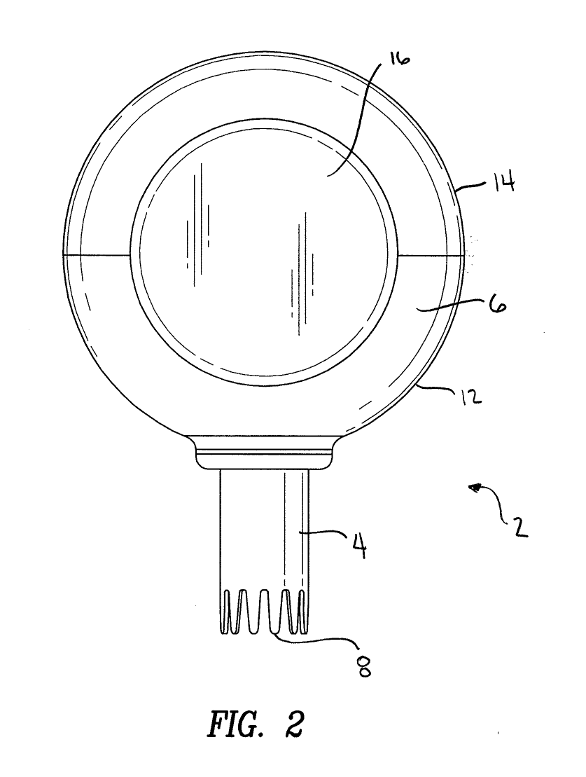

FIGS. 1 to 3 illustrates the preferred embodiment of the present invention, directed to a strawberry huller 2 comprising a tubular member 4 and a receptacle 6 for holding a plurality of stems and cores. The tubular member 4 has a first end 8, with a cutting edge for cutting the stems and cores from a strawberry, a second end 10, associated with the receptacle 6 for delivering the removed stems and cores to the receptacle 6, and a through aperture from the first end 8 to the second end 10. The receptacle 6 of the preferred embodiment shown includes a receptacle body 12 and a cover 14 over an opening on the receptacle body 12 to empty the stems and cores independent of the through aperture of the tubular member 4.

The tubular member 4 is shown to be cylindrical or slightly tapered smaller at the first end 8 to remove the stems and cores of strawberries. The cutting edge at the first end 8 is preferably an undulating or serrated shape to more cleanly cut into the strawberry flesh around the stem and core to be removed. Of course, a straight cutting edge can be used at the first end 8, however, it has been found that the serrated edge creates a cleaner cut when removing the stem and core of a strawberry, especially when inserting and rotating the tubular member 4 into the strawberry.

As the stem and core is removed from a first strawberry it moves into the through aperture of the tubular member 4 and is pushed by successive stems and cores from successive strawberries through the second end 10 of the tubular member 4 into the receptacle 6.

In the preferred embodiment shown, the cover 14 is preferably clear to view the interior of the receptacle 6, for determining when to empty the receptacle, and removably covers an opening across the top of the receptacle 6. The cover 14 can be attached to the receptacle body 12 by any know means, including cooperating threads, clips, tabs, snaps, pins, clasps, etc., however, the use of cooperating snap together elements on the cover 14 and receptacle body 12 is most preferred.

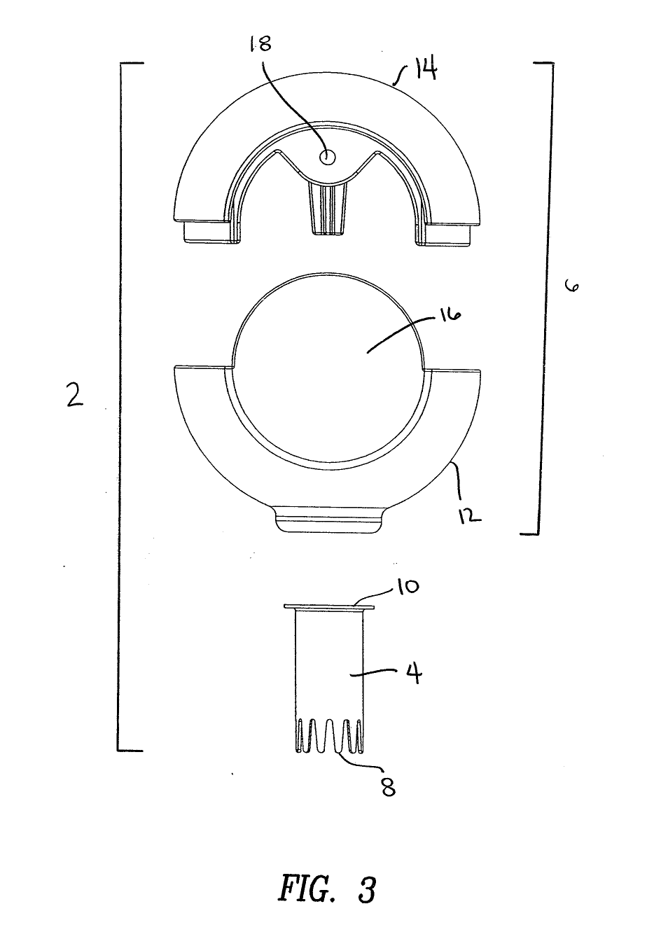

Cooperating snap together elements may be any type. For example, as shown in FIG. 3, one or more nibs 18 may be placed on one or more internal extensions of the cover 14 which fit within the sides of the receptacle body 12. The nib 18 engages a cooperating retention depression (not shown) on the interior of the side of the receptacle body 12, to hold the cover 14 on the receptacle body 12. In this embodiment, the sides of the cover 14 can be pressed together to release the nib 18 from its corresponding retention depression and remove the cover 14 from the receptacle body 12. Alternatively, a tab, depression or other activation feature may be incorporated into the cover 14 receptacle adjacent the cover 12 to assist the user in unseating the cover 14 from the receptacle body 12.

The second end 10 of the tubular member 4 preferably includes a flange or is flared, as shown in FIG. 3, to assist in connecting the tubular member 4 to the receptacle body 12. Using the preferred materials of a food grade stainless steel for the tubular member 4 and a plastic for the receptacle body 6, the second end 10 of the tubular member 4 can be molded into the receptacle body 12 for a secure, permanent connection.

Of course, the tubular member 4 could have a removable attachment to the receptacle body 12, such as by cooperating threads, snap fit, etc., so that the opening of the receptacle is formed where the tubular member 4 is removed. However, it has been found that a permanent attachment of the tubular member 4 to the receptacle body 12, with an opening and a cover 14 at a location remote from the tubular member 4, is preferred.

The receptacle body 12 preferably includes contact areas 16 to grasp the strawberry huller 2 without grasping the cover 14. These contact areas 16 are shown as flattened areas that may comprise tactile features, such as a gnarled surface, an elastomeric coating or material, raised indicia or the like that assists in firmly holding the strawberry huller 2 during use. Internal structural elements may also be included to help maintain the shape of the receptacle body 12 and/or cover 14 when the grip areas 16 are grasped during use.

The receptacle 6 may be of any suitable size and shape, to hold any number of stems and cores with the user being able to manipulate the strawberry huller 2, as a matter of design choice. Notwithstanding, it has been found that the shape shown in the accompanying drawings is easily handled and is intended to be sized so as to hold about 25-35 stems and cores.

Variations, modifications and alterations to the above detailed description will be apparent to those skilled in the art. All such variations, modifications and/or alternatives are intended to fall within the scope of the present invention, limited only by the appended claims. All cited patents and publications are hereby incorporated by reference.

We claim:

1. A strawberry huller comprising;
a tubular member having a first end, a second end and a through aperture, the first end having a cutting edge for cutting the stems and cores from a strawberry; and
a receptacle associated with the with the second end of the tubular member for receiving and retaining a plurality of strawberry stems and cores, the receptacle comprising an opening for removing stems and cores from the receptacle, wherein said opening is independent of the through aperture of the tubular member.

2. The strawberry huller of claim 1 wherein the cutting edge at the first end of the tubular member is a serrated edge.

3. The strawberry huller of claim 1 wherein the receptacle further comprises a receptacle body and a removable cover for sealing the opening of the receptacle.

4. The strawberry huller of claim 3 wherein the cover is clear for viewing the contents of the receptacle.

5. The strawberry huller of claim 3 wherein the cover is removably attached to the receptacle body by cooperating members on the cover and on the receptacle body.

6. The strawberry huller of claim 5 wherein the cover is removably attached to the receptacle body by cooperating snap together elements.

7. The strawberry huller of claim 6 wherein the snap together elements comprise a nib on one of the cover and the receptacle body and a retention depression on the other of the cover and the receptacle body.

8. The strawberry huller of claim 1 wherein the second end of the tubular member is permanently affixed to the receptacle.

9. The strawberry huller of claim 1 wherein the receptacle further comprises structural supports within the receptacle.

10. The strawberry huller of claim 1 wherein the receptacle further comprises contact areas for grasping the strawberry huller.

11. The strawberry huller of claim 10 wherein the contact areas comprise tactile components.

12. The strawberry huller of claim 1 wherein the tubular member is formed of a food grade stainless steel.

13. The strawberry huller of claim 1 wherein the receptacle is formed of plastic.
